(19) United States
(12) Patent Application Publication
(10) Pub. No.: US 2016/0152122 A1
(43) Pub. Date: Jun. 2, 2016

(54) CANOPY ASSEMBLY

(71) Applicant: Caterpillar Paving Products Inc., Brooklyn Park, MN (US)

(72) Inventors: Vasantha P. Arichandran, Maple Grove, MN (US); Nathan L. Mashek, Saint Michael, MN (US)

(73) Assignee: Caterpillar Paving Products Inc., Brooklyn Park, MN (US)

(21) Appl. No.: 15/016,273

(22) Filed: Feb. 5, 2016

(51) Int. Cl. B60J 7/02

(52) U.S. Cl. CPC B60J 7/024; B60Y 2200/22

(57) ABSTRACT

A canopy assembly includes a pillar extendable along a vertical axis to move a canopy assembly from a lowered position to a raised position. A hydraulic actuator disposed within the pillar is fastened to the pillar at a first end and at a second end of the pillar. The pillar includes a locking arrangement to prevent the canopy assembly to move from the raised position to the lowered position. A bracket including a base plate, a first arm, a second arm, a first mounting plate, a second mounting plate, and a third mounting plate, is coupled to the pillar. The second mounting plate and the third mounting plate are adapted to couple the bracket to the pillar. A frame is fastened to the base plate, the first arm and the first mounting plate, and a sunshade is coupled to the frame.

### TECHNICAL FIELD

The present invention relates to a canopy assembly, and more specifically, to a canopy assembly with a single mount bracket having a concealed hydraulic actuation system for adjusting height of the canopy assembly.

### BACKGROUND

Heavy machines such as tractors, cold planers etc, work in a variety of weather conditions. in order to protect an operator from different weather conditions, machines such as, cold planers generally include a canopy over the operator's seat.

Currently, the canopies provided in cold planers are mounted on two pillars or four pillars. However, multiple pillars restrict visibility of the operator, making it difficult to operate the cold planer. Single pillar canopies are also known on machines such as tractors, but such canopies are difficult to design as it is challenging for the single pillar to withstand various loads that the canopy is subjected to during working conditions. Also, while transporting the machine, the canopy is subjected to heavy wind loads, Which causes heavy loading of such canopies. Further, during transportation, or during various working conditions, height of the canopy needs to be adjusted. For example, while operating the cold planer, height of the canopy may need to be lowered in case of any aerial obstacle, for example tree branches. While adjusting the height of the canopy, many currently available canopy designs obstruct visibility of the operator. Therefore, there is a need for a canopy that is easily adjustable and does not restrict the visibility of the operator, and is able to withstand the load during operation and transportation of the machine.

Japanese Publication Number 10157465 discloses a sunvisor device for a working vehicle. The reference discloses a support column at the lateral or rear side of the driver's seat and the sunvisor connected to the upper end of the column. The support column incorporates a hydraulic cylinder for extension or contraction of the shaft. The sunvisor mounted on the column moves up and down according to the extension or contraction of the hydraulic cylinder. However, such sunvisors are susceptible to damage as they cannot withstand wind load, Also, the hydraulic cylinder is subjected to load in such a design increasing the likelihood of failure of the hydraulic cylinder, and a risk of injury to the operator. Therefore, there is a need for an improved canopy assembly which minimizes a risk of injury to the operator.

### SUMMARY OF THE DISCLOSURE

In one aspect of the present disclosure, a canopy assembly movable between a raised position and a lowered position is provided. The canopy assembly includes a pillar having a first end and a second end. The pillar is extendable along a vertical axis to move the canopy assembly from the lowered position to the raised position. A hydraulic actuator is disposed within the pillar, and is fastened to the pillar at the first end and at the second end. A locking arrangement is provided to prevent the canopy assembly to move from the raised position to the lowered position. A bracket is coupled to the pillar at the second end. The bracket includes a base plate, a first arm, arranged perpendicular to the base plate, and a second arm arranged perpendicular to the base plate. The second arm is arranged parallel to the first arm across a width of the base plate. The bracket further includes a first mounting plate, a second mounting plate and a third mounting plate. The first mounting plate is attached to the base plate. the first arm and the second arm, at a first edge of the bracket. The second mounting plate is attached to the base plate, the first arm and the second arm, and is disposed at a first predetermined distance from the first mounting plate along a length of the base plate. The third mounting plate is attached to the base plate, the first arm and the second arm, and is disposed at a second predetermined distance from the second mounting plate along the length of the base plate. The first mounting plate, the second mounting plate, and the third mounting plate are disposed parallel to each other. The second mounting plate and the third mounting plate are adapted to couple the bracket to the pillar at the second end of the pillar. A frame is fastened to the base plate, the first arm and the first mounting plate and a sunshade is coupled to the frame.

Other features and aspects of this disclosure will be apparent from the following description and the accompanying drawings.

### BRIEF DESCRIPTION OF THE DRAWINGS

FIG. 1 is a perspective view of a cold planer with a canopy assembly, in accordance with an embodiment of the present disclosure;

FIG. 2 is an exploded view of the canopy assembly, in accordance with the concepts of the present disclosure;

FIG. 3 is an exploded view of a bracket and a frame, in accordance with the concepts of the present disclosure; and

FIG. 4 is a sectional view of a pillar and a hydraulic actuator disposed within the pillar, in accordance with the concepts of the present disclosure.

### DETAILED DESCRIPTION

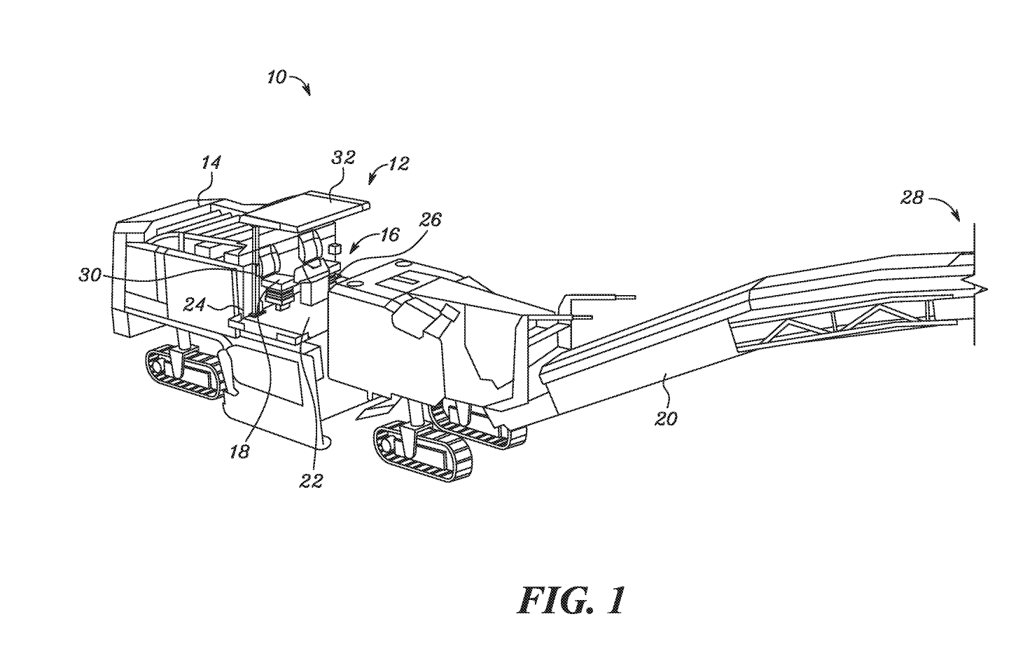

Referring to FIG. 1, a cold planer 10 includes an engine 14, an operator cabin 16, an operator seat 18, and a loading conveyor 20. The cold planer 10 further includes various other components, such as, undercarriage assembly, tracks, exhaust, fuel tank etc. For the purpose of simplicity, the various components of the cold planer 10 are not labeled in FIG. 1. The operator cabin 16 of the cold planer 10 includes a floor 22 of the operator cabin 16, a first corner 24 and a second corner 26 of the operator cabin 16 and a canopy assembly 12. The operator seat 18 faces a forward end 28 of the cold planer 10. The canopy assembly 12 further includes a pillar 30 and a sunshade 32. The canopy assembly 12 is mounted on the cold planer 10 by fastening the pillar 30 to the floor 22 of the operator cabin 16, at the first corner 24 of the operator cabin 16, Further, the sunshade 32 of the canopy assembly 12 is disposed above the operator seat 18 and covers a substantial portion of the operator cabin 16.

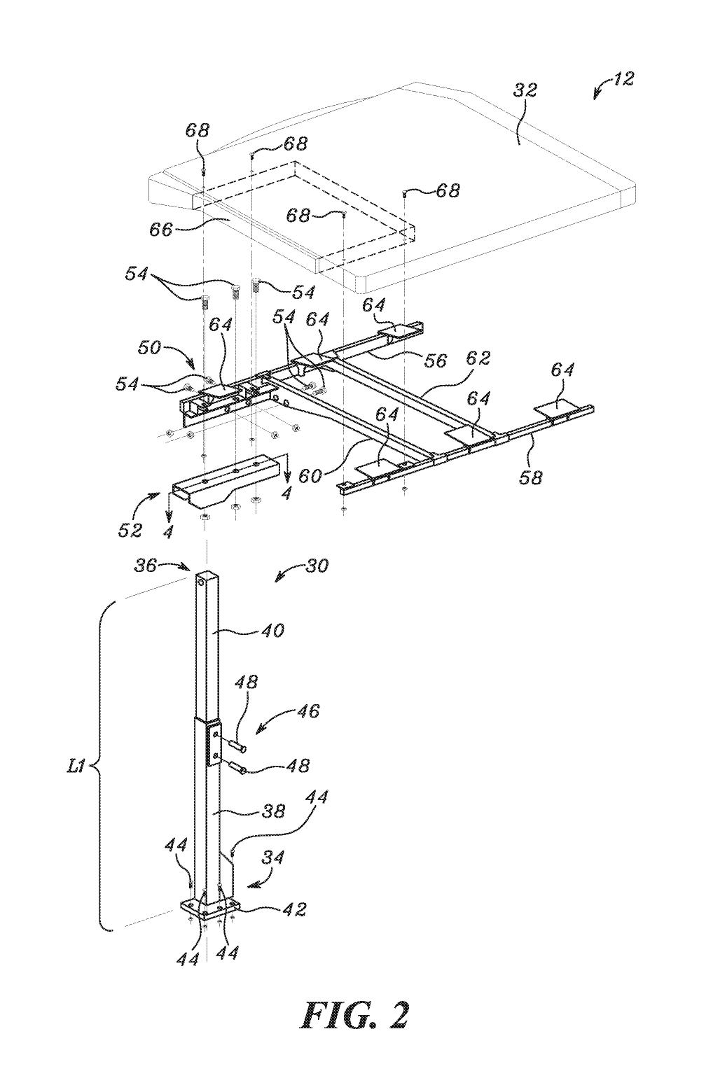

Referring to FIG. 2, the canopy assembly 12 includes the pillar 30 having a first end 34 and a second end 36. The pillar 30 further includes an outer column 38 and an inner column 40. The outer column 38 of the pillar 30 includes a base 42 at the first end 34. In order to mount the canopy assembly 12 to the cold planer 10, the base 42 of the pillar 30 is fastened to the floor 22 of the operator cabin 16, using a number of first fasteners 44. The inner column 40 is designed to slide within the outer column 38, which enables the pillar 30 to extend along a length L1 of the pillar 30. Consequently, the canopy assembly 12 is able to move from a lowered position (not shown) to a raised position. In order for the pillar 30 to extend along the length L1, a hydraulic actuator (not shown) is disposed within the pillar 30, which raises or lowers the pillar 30, in turn, raising or lowering the canopy assembly 12.

A locking arrangement 46 is provided in the pillar 30 to lock the pillar 30 in a raised position. The locking arrangement 46 includes a number of locking pins 48, adapted to prevent the inner column 40 to slide within the outer column 38, and in turn, prevent the canopy assembly 12 to move from the raised position to the lowered position. In another embodiment, the locking arrangement 46 includes a number of fasteners (not shown) that are used to lock the pillar 30 in the raised position. The fasteners may be tightened against a surface of the inner column 40 to prevent the inner column 40 to slide within the outer column 38 along the length L1.

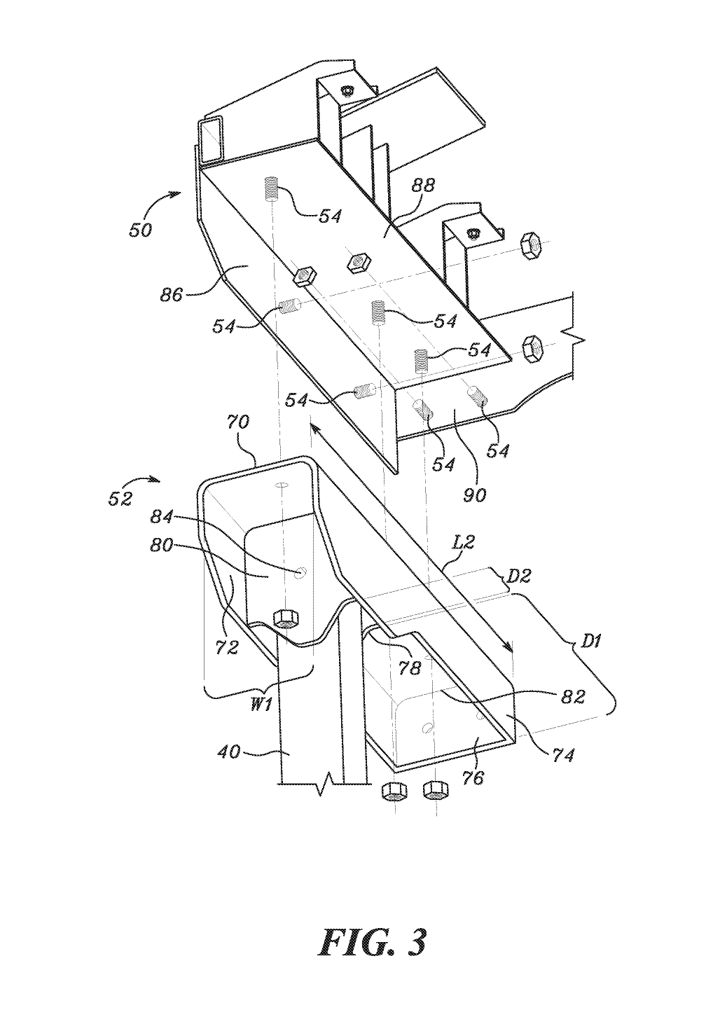

The pillar 30 is coupled to a frame 50 of the canopy assembly 12 at the second end 36 of the pillar 30, using a bracket 52 (described in conjunction with FIG. 3). The bracket 52 is coupled to the pillar 30 using one or more of, but not limited to, weld joints, fasteners, and adhesive. The bracket 52 is further coupled to the frame 50 using a number of second fasteners 54. The frame 50 includes a first rail 56 and a second rail 58 disposed parallel to each other and connected to each other using a first bar 60 and a second bar 62. The frame 50 of the canopy assembly 12 is coupled to the sunshade 32 using a number of support members 64. As an example, the support members 64 are bonded to the sunshade 32 using, but not limited to, an adhesive. Optionally, the sunshade 32 includes a member 66 which is extendable to increase a surface area of the sunshade 32. The member 66 is assembled with the sunshade 32 using a number of third fasteners 68.

Referring to FIG. 3, the bracket 52 includes abase plate 70, a first arm 72 and a second arm 74. The first arm 72 and the second arm 74 are attached to the base plate 70, and arranged perpendicular to the base plate 70. Further, the first arm 72 and the second arm 74 are disposed parallel to each other across a width W1 of the base plate 70. The bracket 52 further includes a first mounting plate 76, a second mounting plate 78 and a third mounting plate 80. The first mounting plate 76 is attached to the base plate 70, the first arm 72 and the second arm 74 at a first edge 82 of the bracket 52. Similarly, the second mounting plate 78 is attached to the base plate 70, the first arm 72 and the second arm 74 at a first predetermined distance D1 from the first mounting plate 76 along a length L2 of the base plate 70, Further, the third mounting plate 80 is attached to the base plate 70, the first arm 72 and the second arm 74 at a second predetermined distance D2 from the second mounting plate 78 along the length L2 of the base plate 70. The first mounting plate 76, the second mounting plate 78 and the third mounting plate 80 are disposed parallel to each other. The second mounting plate 78 and the third mounting plate 80 include holes 84 for mounting a hydraulic actuator not shown).

Further, the frame 50 includes a first plate 86, a second plate 88, and a third plate 90. The first plate 86 is coupled with the first arm 72, the second plate 88 is coupled with the base plate 70, and the third plate 90 is coupled with the first mounting plate 76, using the second fasteners 54. In another embodiment, the first plate 86, the second plate 88, and the third plate 90 is bonded to the first arm 72, the base plate 70, and the first mounting plate 76.

The frame 50 coupled with the bracket 52 is further adapted to mount the sunshade 32 on the pillar 30. In order to mount the frame 50 and the bracket 52, the second mounting plate 78 and the third mounting plate 80 are coupled to the pillar 30. As an example, the second mounting plate 78 and the third mounting plate 80 are welded to the pillar 30 at the second end 36.

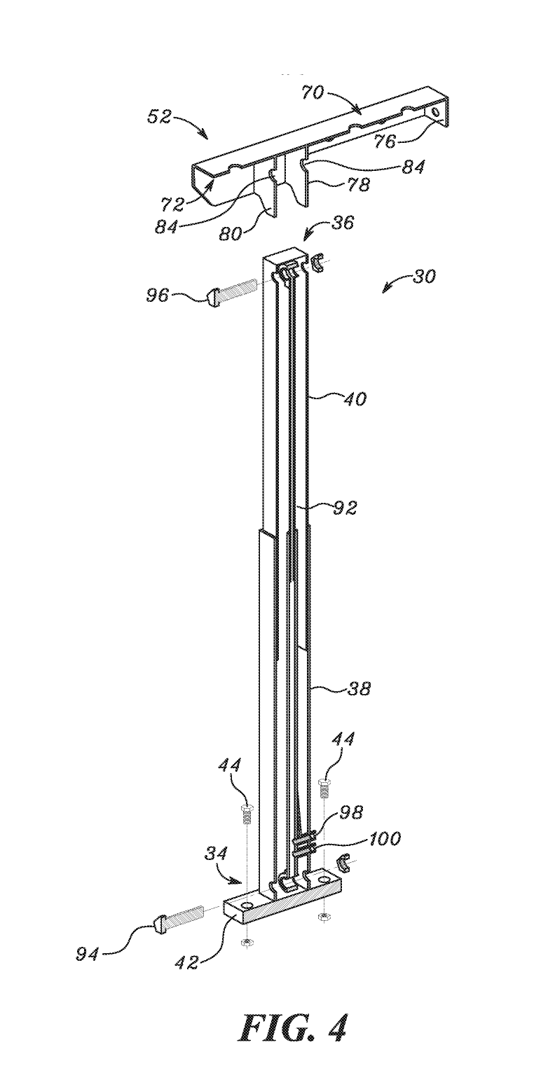

FIG. 4 is a sectional view of the pillar 30 and a hydraulic actuator 92 taken along axis 4-4 of FIG. 2, in accordance with the concepts of the present disclosure. The hydraulic actuator 92 is disposed within the pillar 30 and is adapted to move the canopy assembly 12 to the raised position from the lowered position and vice versa. The hydraulic actuator 92 is coupled to the outer column 38 at the first end 34 of the pillar 30 by a fourth fastener 94. Similarly, the hydraulic actuator 92 is coupled to the inner column 40 at the second end 36 of the pillar 30 by a fifth fastener 96. The hydraulic actuator 92 further includes an inlet port 98 for inlet of pressure oil and an outlet port 100 for outlet of the pressure oil. The inlet port 98 and the outlet port 100 facilitate supplying the pressure oil to the hydraulic actuator 92 in order to extend and retract the hydraulic actuator 92. This in turn enables the canopy assembly 12 to move from the lowered position to the raised position. In an embodiment a number of liners (not shown) are provided between an inner surface of the outer column 38 and an outer surface the inner column 40.

It will be apparent to one skilled in the art that the use of the canopy assembly 12 is not limited to the cold planer 10. The canopy assembly 12 may be utilized in various other heavy machines. Examples of different types of heavy machines include, but not limited to, a tractor, a dozer and a motor grader. Further, although the pillar 30 is shown fastened to the floor 22 at the first corner 24, it will be apparent to one skilled in art that the pillar 30 may be fastened to the floor 22 at the second corner 26 of the operator cabin 16, without departing from the scope of the present disclosure. Further, a material of construction of the bracket 52 includes, but not limited to iron, steel, copper, bronze, or any other suitable metal or metal alloy. Also, a material of construction of the frame 50 includes, but not limited to, iron, steel, copper, bronze, or any other suitable metal or metal alloy. Further, a material of construction of the pillar 30 includes, but not limited to, iron, steel, copper, bronze, or any other suitable metal or metal alloy. Further, a material of construction of the sunshade 32 includes, but not limited to, plastic, linen, polyester, and Polyethylene Terephthalate. Furthermore, it is apparent to one skilled in the art that movement of the canopy assembly 12 between the raised position and the lowered position is not limited to the use the hydraulic actuator 92. Further, although in the description, the hydraulic actuator 92 is shown, the canopy assembly 12 may be moved between the raised position and the lowered position using other forms of actuators, such as, but not limited to, pneumatic actuators.

### INDUSTRIAL APPLICABILITY

Cold planers generally do not include a closed cabin for the operator of the machine. In order to protect the operator from different weather conditions, the cold planers include a canopy over the operator's seat. Such canopies are generally mounted on multiple pillars, which restrict visibility of the operator. Single pillar canopies are also known, but are susceptible to failure as the single pillar is not able to withstand various loads that the canopy is subjected to during working or transportation of the cold planer. The canopy is subjected to wind load while transportation, which causes failure of the canopy, thereby increasing chances of injury to the operator. Also, the current canopy designs are difficult to operate as adjusting the height of the canopy obstructs visibility of the operator.

The present disclosure provides the canopy assembly 12 movable between the raised position and the lowered position. The canopy assembly 12 includes the pillar 30 mounted at the first corner 24 of the operator cabin 16. The first corner 24 of the operator cabin 16 is opposite to the forward end 28 of the cold planer 10. Such type of arrangement provides a clear view of surrounding working conditions, and thus ensures unrestricted visibility to the operator. The pillar 30 is extendable along the length L1 using the hydraulic actuator 92, thereby making height of the canopy assembly 12 adjustable for smooth transportation of the cold planer 10. In order to operate the canopy assembly 12, the operator loosens the locking pins 48 and actuates the hydraulic actuator 92 by pressing a switch/button provided in the operator cabin 16. Upon pressing of the switch/button, the hydraulic actuator 92 extends or retracts the pillar 30, thereby changing height of the canopy assembly 12. The hydraulic actuator 92 is coupled with the first end 34 and the second end 36 of the pillar 30, thus the hydraulic actuator 92 is not subjected to the load of the canopy assembly 12 and also not subjected to wind load during transportation of the cold planer 10. The sunshade 32 and the frame 50 can be easily removed by unfastening the second fasteners 54. The bracket 52 is fastened to the frame 50 at three sides of the bracket 52, which allows the canopy assembly 12 to withstand the wind load during transportation. Also, the locking arrangement 46 is adapted to lock the canopy assembly 12 in the raised position, thereby, preventing the canopy assembly 12 from falling on an operator in case a pressure of oil in the hydraulic actuator 92 decreases. Thus, the canopy assembly 12 ensures complete safety of the operator.

The liners provided in the pillar 30 absorb a wear arising due to relative movement between the outer column 38 and the inner column 40, thereby preventing a wear in the outer column 38 and the inner column 40. Further, in an embodiment the locking arrangement 46 includes a number of fasteners, which are used to prevent a shaking in the pillar 30, arising out of a clearance provided between the outer column 38 and the inner column 40. This in turn allows a smooth relative movement between the outer column 38 and the inner column 40, when the canopy assembly 12 moved into the lowered position and vice versa. Optionally, the sunshade 32 includes the member 66 which is extendable to increase a surface area of the sunshade 3 providing increased comfort to an operator.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A canopy assembly movable between a raised position and a lowered position, the canopy assembly comprising:
a pillar having a first end and a second end, wherein the pillar is extendable along a vertical axis to move the canopy assembly from the lowered position to the raised position, the pillar having:
a hydraulic actuator disposed within the pillar, the hydraulic actuator fastened to the pillar at the first end and at the second end; and
a locking arrangement adapted to prevent the canopy assembly
to move from the raised position to the lowered position;
a bracket coupled to the pillar at the second end, the bracket having:
a base plate;
a first arm, arranged perpendicular to the base plate;
a second arm arranged perpendicular to the base plate, wherein the second arm is arranged parallel to the first arm across a width of the base plate;
a first mounting plate attached to each of the base plate, the first arm and the second arm, at a first edge of the bracket;
a second mounting plate attached to each of the base plate, the first arm and the second arm, the second mounting plate disposed at a first predetermined distance from the first mounting plate along a length of the base plate; and
a third mounting plate attached to each of the base plate, the first arm and the second arm, the third mounting plate disposed at a second predetermined distance from the second mounting plate along the length of the base plate;
wherein each of the first mounting plate, the second mounting plate, and the third mounting plate is disposed parallel to each other, the second mounting plate and the third mounting plate adapted to couple the bracket to the pillar at the second end of the pillar;
a frame fastened to each of the base plate, the first arm and the first mounting plate; and
a sunshade coupled to the frame.
